(19) United States
(12) Patent Application Publication
(10) Pub. No.: US 2025/0033451 A1
(43) Pub. Date: Jan. 30, 2025

(54) VEHICLE ASSEMBLY AND FRAME MOUNT THEREFOR

(71) Applicant: JAGUAR LAND ROVER LIMITED, Coventry (GB)

(72) Inventors: Niall SHIMMIN, Coventry (GB); Alex WATSON, Coventry (GB); Thomas MARSHALL, Stratford Upon Avon (GB)

(21) Appl. No.: 18/360,401

(22) Filed: Jul. 27, 2023

(51) Int. Cl. B60K 1/04; B62D 21/09

(52) U.S. Cl. CPC B60K 1/04; B62D 21/09; B60K 2001/0438

(57) ABSTRACT

Aspects of the disclosure relate to a vehicle assembly, to a frame mount for a vehicle assembly, and to a vehicle. The frame mount comprising an elongate body having a first edge region and a second edge region, the second edge region spaced apart from and inclined relative to the first edge region for attachment to a battery housing.

### TECHNICAL FIELD

The present disclosure relates to a vehicle assembly and a frame mount therefor. Aspects of the invention relate to a vehicle assembly, to a frame mount for a vehicle assembly, and to a vehicle.

### BACKGROUND

It is known to provide the battery pack of an electric vehicle (EV) in the underfloor area of the vehicle. This location provides several advantages, including lowering the centre of gravity of the vehicle which improves composure and handling. The battery pack is typically positioned toward the middle of the underfloor area, between the front and rear axles, as such placement helps to achieve a more balanced weight distribution. However, breakover clearance requirements are most severe at the midpoint between the axles. Breakover clearance, also referred to breakover angle or ramp angle, is a measurement of a vehicle's ability to pass over an obstacle without getting stuck or making contact; it is an important measurement for off-road vehicles. Placement of a vehicle's components in the underfloor area can reduce the breakover clearance, particularly when placed at or toward the midpoint between the axles.

It is desirable to maximise the available volume for the battery pack in the underfloor area of the vehicle without compromising breakover clearance requirements. Such maximisation may, in certain circumstances, be optimally afforded by means that are not onerous to incorporate into existing or conventional vehicle designs, allowing manufacturers to leverage their existing production infrastructure, supply chains and manufacturing processes.

It is an aim of the present invention to address one or more of the disadvantages associated with the prior art.

### SUMMARY OF THE INVENTION

Aspects and embodiments of the invention provide a vehicle assembly, a frame mount for a vehicle assembly, and a vehicle as claimed in the appended claims.

According to an aspect of the invention, there is provided a vehicle assembly comprising: a battery housing; and a frame mount. The frame mount may comprise an elongate body. The elongate body may have a first edge region and a second edge region. The second edge region may be spaced apart from the first edge region. The second edge region may be inclined relative to the first edge region. The second edge region may be attached to the battery housing. The second edge region may extend substantially parallel to a principal axis of the battery housing.

According to another aspect of the invention, there is provided a vehicle assembly comprising: a battery housing; and a frame mount comprising an elongate body having a first edge region and a second edge region, the second edge region spaced apart from and inclined relative to the first edge region and attached to and extending substantially parallel to a principal axis of the battery housing.

According to yet another aspect of the invention, there is provided a frame mount for a vehicle assembly, the frame mount comprising an elongate body. The body may have a first edge region and a second edge region. The first edge region may be attachment to a frame member of a vehicle assembly. The second edge region may be spaced apart from the first edge region. The second edge region may be inclined relative to the first edge region. The second edge region may be for attachment to a battery housing.

According to another aspect of the invention, there is provided a frame mount for a vehicle assembly, the frame mount comprising: an elongate body having a first edge region and a second edge region, the first edge region for attachment to a frame member of a vehicle assembly and the second edge region spaced apart from and inclined relative to the first edge region for attachment to a battery housing.

The frame mount may maximise use of the available battery volume in an underfloor area of a vehicle while balancing breakover clearance requirements. This, in turn, may allow for larger sized batteries located in the centre of the underfloor area, allow for typical location of a fuel tank in a hybrid electric vehicle (HEV) or plug-in hybrid electric vehicle (PHEV), and/or protect boot space capacity. Moreover, the frame mount is not onerous to incorporate into existing or conventional vehicle designs, allowing manufacturers to leverage their existing production infrastructure, supply chains and manufacturing processes.

Additionally, or alternatively, the frame mount may improve breakover clearance. A larger breakover a clearance, i.e. breakover or ramp angle, provides better off-road capability, as it allows the vehicle to navigate steeper obstacles or uneven terrain without damaging the undercarriage of the vehicle.

In certain embodiments, the vehicle assembly may comprise a frame member, the first edge region being attached to the frame member thereby mounting the battery housing to the frame member such that the principal axis of the battery housing is inclined relative to a longitudinal axis of the frame member. The principal axis of the battery housing may be inclined relative to the longitudinal axis of the frame member by at least 1° and/or up to 5°. Higher angles allow for increased breakover clearance.

In certain embodiments, the first edge region may extend substantially parallel to the longitudinal axis of the frame member. Such parallel alignment may facilitate assembly/manufacture, and in particular may facilitate incorporation of an inclined battery housing into existing or conventional vehicle designs

In certain embodiments, the frame mount may comprise a first planar region and a second planar region, the first planar region extending between the first edge region and the second edge region, and the second planar region extending adjacent the first edge region and perpendicular to the first planar region. The first planar region provides a surface over which the battery housing may be attached to the frame mount. The second planar region provides a surface and/or projection orientated for facilitating attachment of the frame mount to the frame member. The second planar region may comprise one or more apertures extending perpendicularly therethrough, each of the apertures for receiving a respective fastener. The apertures may further facilitate attachment of the frame mount to the frame member.

In certain embodiments, the frame mount may substantially take the form of an L-section having a web and a flange, the web comprising the first planar region and the flange comprising the second planar region. Providing the frame mount in the form of an L-section may provide good strength to weight characteristics and/or facilitate manufacture, including that the frame mount may be manufactured by extrusion. The web may comprise a first portion that is double-walled and thereby may comprise an aperture extending along a length thereof. This arrangement may further improve the strength to weight characteristics of the frame mount.

In certain embodiments, the web may comprise a second portion that is single-walled and comprises the second edge region. This arrangement may facilitate manufacture of the frame mount by extrusion, the double-walled first portion needing a uniform cross-section along its length, and the single-walled second portion being formed first by extrusion and subsequently by machining to form the second edge region inclined relative to the first edge region, i.e. material is removed to form the second edge region.

In certain embodiments, the flange is double-walled and thereby comprises an aperture extending along a length thereof. This arrangement may further improve the strength to weight characteristics of the frame mount.

According to another aspect of the invention, there is provided a vehicle comprising a vehicle assembly and/or a frame member as described above.

According to yet another aspect of the invention there is provided a vehicle comprising: a battery housing having a principal axis inclined relative to the horizontal when the vehicle is at rest on a horizontal driving surface. The principal axis of the battery housing may be inclined relative to the horizontal by at least 1° and/or up to 5°. The battery housing may be disposed in an underfloor area of the vehicle and between spaced apart axles of the vehicle.

Inclination of the battery relative to the horizontal may maximise use of the available battery volume in an underfloor area of a vehicle while balancing breakover clearance requirements. This, in turn, may allow for larger sized batteries located in the centre of the underfloor area, allow for typical location of a fuel tank in a HEV or PHEV, and/or protect boot space capacity. Moreover, such inclination of the battery, may improve breakover clearance. A larger breakover a clearance, i.e. breakover or ramp angle, provides better off-road capability, as it allows the vehicle to navigate steeper obstacles or uneven terrain without damaging the undercarriage of the vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic side view of a vehicle assembly according to an embodiment of the invention;

FIG. 2 shows a schematic perspective partial underside view of the vehicle assembly of FIG. 1, the assembly including a frame member;

FIG. 3 shows a schematic perspective partial end view of the vehicle assembly of FIG. 1;

FIG. 4 shows a further schematic perspective partial end view of the vehicle assembly of FIG. 1;

FIG. 5 shows a schematic perspective view of a vehicle according to an embodiment of the invention.

### DETAILED DESCRIPTION

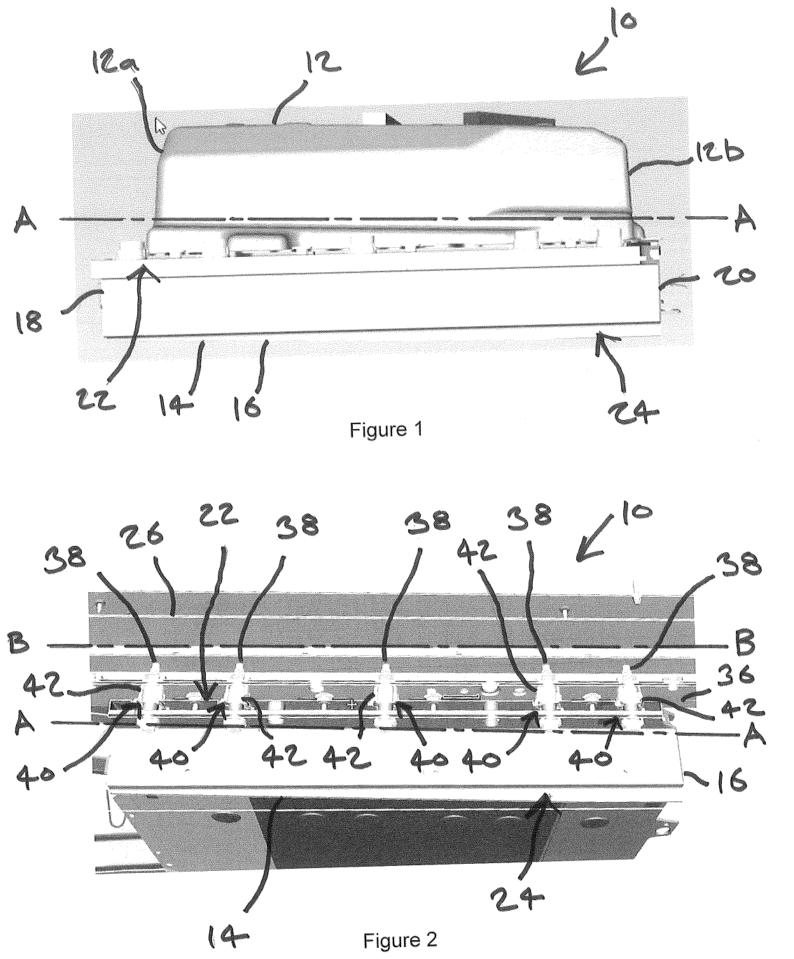

FIGS. 1 to 4 show a vehicle assembly 10 according to an embodiment of the invention. The vehicle assembly 10 may have particular application for use in an electric vehicle (EV), for example a hybrid electric vehicle (HEV) or a plug-in hybrid electric vehicle (PHEV).

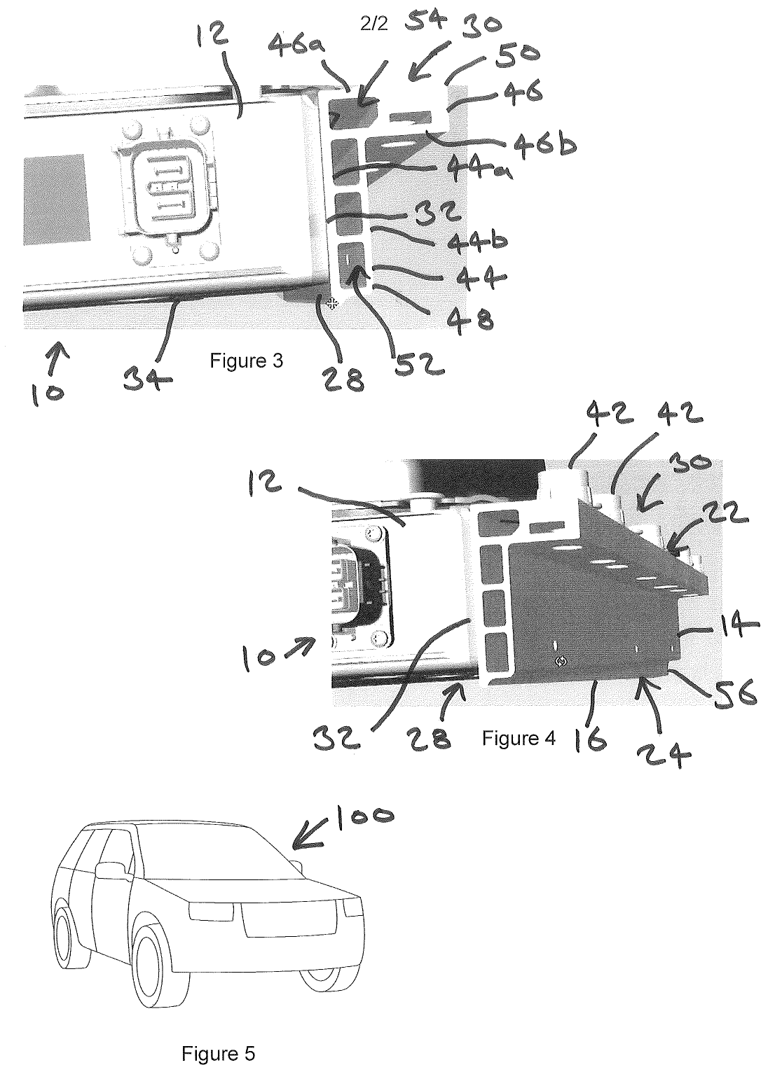

The vehicle assembly 10 comprises a battery housing 12 and a frame mount 14. The battery housing 12 provides a protective enclosure for containing a battery pack and protects the battery pack from, for example, physical damage, moisture and other external factors that may pose a risk to integrity and/or performance of the battery pack. The battery housing 12 has a principal axis A-A extending through the centre thereof. In use, the principal axis A-A extends generally between the front and the rear of a vehicle 100 (shown in FIG. 5). The frame mount 14 has an elongate body 16 extending between first and second ends 18, 20 of the frame mount 14. The body 16 has a first edge region 22 and an opposing second edge region 24. The edge regions 22, 24 extend between the first and second ends 18, 20 of the frame mount 14. As in the illustrated embodiment, the edge regions 22, 24 may be substantially straight edges. Each of the edge regions 18, 20 may define an outermost extremity or peripheral edge of the frame mount 14.

The second edge region 24 is spaced apart from and inclined relative to the first edge region 22, i.e. the edge regions 22, 24 are not parallel to one another, and the second edge region 24 is attached to the battery housing 12. More specifically, the second edge region 24 is attached to the battery housing 12 such that the second edge region 24 extends substantially parallel to the principal axis A-A of the battery housing 12. Consequently, the first edge region 22 does not extend parallel to the principal axis A-A. Attachment of the second edge region 24—and, more generally, the frame mount 14—to the battery housing 12 may be by any suitable means, including rivets, releasable fasteners and/or adhesives.

Referring to FIG. 2, the vehicle assembly 10 may further comprise a frame member 26, which may form part of a chassis of the vehicle 100. The frame member 26 has a longitudinal axis B-B extending through the centre thereof. In certain embodiments, the longitudinal axis B-B may be substantially horizontal when the vehicle 100 is at rest on a horizontal driving surface. In use, the first edge region 22 may be attached to the frame member 26, thereby mounting the battery housing 12 to the frame member 26. As the second edge region 24 is inclined relative to the first edge region 22, the attachment of the first edge region 22 to the frame member 26 may result in the principal axis A-A of the battery housing 12 being inclined relative to the longitudinal axis B-B of the frame member 26, at least in embodiments where the first edge region 22 extends substantially parallel to the longitudinal axis B-B of the frame member 26 when the frame mount 14 is attached thereto. In any event, it is intended that the principal axis A-A of the battery housing 12 is inclined relative to the horizontal when the vehicle 100 is at rest on a horizontal driving surface, and thereby the battery housing 12 is generally inclined relative to the horizontal also.

This above-described arrangement results in a first end 12a of the battery housing 12b being disposed further from the driving surface than an opposing second end 32 of the battery housing 12. Consequently, in embodiments having the battery housing 12 disposed in an underfloor area of the vehicle 100 and between spaced apart axles of the vehicle 100, it is possible to align, or at least more closely align, the principal axis A-A of the battery housing 12 with the breakover clearance of the vehicle 100. This may maximise use of the available battery volume in the underfloor area while balancing breakover clearance requirements and/or improve breakover clearance. This makes possible larger sized batteries located in the centre of the underfloor area. Additionally, or alternatively, an inclined battery housing 12 may facilitate incorporation of larger sized batteries into existing or conventional vehicle designs, allowing for typical location of a fuel tank in a HEV or PHEV version of an existing vehicle design and/or and protecting boot space capacity of same.

In certain embodiments, the principal axis A-A of the battery housing 12 may be inclined relative to the longitudinal axis of the frame member by at least 1° and/or up to 5°. However, the precise angle will depend upon the size of the battery housing 12 and/or the desired breakover clearance. Suitable angles of inclination include 1°, 1.28°, 1.5°, 2°, 2.5°, 2.78°, 3°, 4° and 5°.

Now referring to FIGS. 3 and 4, the frame mount 14 may comprise a first planar region 28 extending between the first edge region 22 and the second edge region 24, and a second planar region 30 extending adjacent the first edge region 22 and perpendicular to the first planar region 28. The first and second planar regions 28, 30 may serve principally as abutment surfaces to facilitate attachment of the frame mount 14 to the frame member 26 and to the battery housing 12, respectively. The first planar region 28 may form part of each of the first and second edge regions 22, 24. A side 32 of the battery housing 12 may be attached to, or against, the first planar region 28 about a periphery thereof. FIG. 3 shows the second edge region 22 extending parallel to an underside 34 of the battery housing 12, a peripheral edge 22a of the of the second end region 22 being offset from the underside 34. However, in certain embodiments, the offset may not be present. The underside 34 may be substantially parallel to the principal axis A-A of the battery housing 12.

Referring again to FIG. 2, the frame mount 14 may be attached to a lower surface 36 of the frame member 26, for example an underside of a lower flange of the frame member 26. This permits attachment by a plurality of fasteners 38, for example bolts, extending through the second planar region 28. To this end, as shown in the illustrated embodiment, the second planar region 28 may comprise one or more apertures 40 extending therethrough, each of the apertures 40 suitable for receiving a respective fastener 38. In the illustrated embodiment, the apertures 40 extend perpendicularly through the second planar region 28. This is possible because the first edge region 22 extends substantially parallel to the longitudinal axis B-B of the frame member 26—or, more specifically, to the lower surface 36, which is itself parallel to the longitudinal axis B-B—when the frame mount 14 is attached thereto. This arrangement makes certain embodiments particularly suitable to incorporate into existing or conventional vehicle designs, since the interface between the frame mount 14 and the frame member 26 may be similar to, or substantially the same as, that in conventional vehicle designs.

Attachment of the frame mount 14 to the frame member 26 may be direct or indirect. In the illustrated embodiment, attachment of the frame mount 14 to the frame member 26 is indirect, having a plurality of spacers 42 being interposed there between. The fasteners 38 pass though the spacers 42. The spacers 42 allow the position of the battery housing 12 relative to the frame member 26 to be varied, for example to accommodate different sizes of the battery housing 12.

As shown in the illustrated embodiment, the frame mount 14 may substantially takes the form of an L-section, or an L-shaped unequal angle, having a web 44 and a flange 46. The web 44 comprises the first planar region 28 and the flange 46 comprises the second planar region 30. Providing the frame mount 14 as an L-section means that the frame mount 14 may be produced as a single, monolithic piece. The frame mount 14 may be extruded. Such an arrangement may have good strength to weight characteristics. To further improve the strength to weight characteristics, both the web 44 and the flange 46 may be double-walled, i.e. may comprise a respective double walled-portion 48, 50. FIGS. 3 and 4, show spaced apart first and second walls 44a, 44b of the web 44, and spaced apart first and second walls 46a, 46b of the flange 46. Respective apertures 52, 54 extend along the length of the frame member 14 between the first and second walls 44a, 44b of the web 44, and the first and second walls 46a, 46b of the flange 46. If the web 44 is double-walled, it must also include a single-walled portion 56 if it is desired to manufacture the frame mount 14 by extrusion, since the second edge region 22 must be machined post extrusion to remove material such that the second edge region 24 is inclined relative to the first edge region 22.

Generally, embodiments of the invention provide for supporting the battery housing 12 on the vehicle 100, wherein the battery housing 12 is inclined relative to horizontal when the vehicle 100 is at rest on a horizontal driving surface.

The invention is not limited by the foregoing embodiments. For example, as the skilled reader will appreciate, the size and shape of the battery housing 12 may vary depending on the specific application, i.e. vehicle type, version, etc., though the battery housing 12 may be rectangular or cubiform. The battery housing 12 shown in the illustrated embodiment is cubiform.

It will be appreciated that various changes and modifications can be made to the present invention without departing from the scope of the present application.

1. A vehicle assembly comprising:
a battery housing; and
a frame mount comprising an elongate body having a first edge region and a second edge region, the second edge region spaced apart from and inclined relative to the first edge region and attached to and extending substantially parallel to a principal axis of the battery housing.

2. The vehicle assembly according to claim 1, further comprising a frame member and wherein the first edge region is attached to the frame member thereby mounting the battery housing to the frame member such that the principal axis of the battery housing is inclined relative to a longitudinal axis of the frame member.

3. The vehicle assembly according to claim 2, wherein the principal axis of the battery housing is inclined relative to the longitudinal axis of the frame member by at least 1° and/or up to 5°.

4. The vehicle assembly according to claim 2, wherein the first edge region extends substantially parallel to the longitudinal axis of the frame member.

5. The vehicle assembly according to claim 1, wherein the frame mount comprises a first planar region and a second planar region, the first planar region extending between the first edge region and the second edge region, and the second planar region extending adjacent the first edge region and perpendicular to the first planar region.

6. The vehicle assembly according to claim 5, wherein the second planar region comprises one or more apertures extending perpendicularly therethrough, each of the one or more apertures for receiving a respective fastener.

7. The vehicle assembly according to claim 5, wherein the frame mount substantially takes the form of an L-section having a web and a flange, the web comprising the first planar region and the flange comprising the second planar region.

8. The vehicle assembly according to claim 7, wherein the web comprises a first portion that is double-walled and thereby comprises an aperture extending along a length thereof.

9. The vehicle assembly according to claim 8, wherein the web comprises a second portion that is single-walled and comprises the second edge region.

10. The vehicle assembly according to claim 7, wherein the flange is double-walled and thereby comprises an aperture extending along a length thereof.

11. A frame mount for a vehicle assembly, the frame mount comprising:
an elongate body having a first edge region and a second edge region, the first edge region for attachment to a frame member of the vehicle assembly and the second edge region spaced apart from and inclined relative to the first edge region for attachment to a battery housing.

12. The frame mount according to claim 11, wherein the frame mount comprises a first planar region and a second planar region, the first planar region extending between the first edge region and the second edge region, and the second planar region extending adjacent the first edge region and perpendicularly to the first planar region.

13. The frame mount according to claim 12, wherein the second planar region comprises one or more apertures extending perpendicularly therethrough, each of the one or more apertures for receiving a respective fastener.

14. The frame mount according to claim 12, wherein the frame mount substantially takes the form of an L-section having a web and a flange, the web comprising the first planar region and the flange comprising the second planar region.

15. The frame mount according to claim 14, wherein the web comprises a first portion that is double-walled and thereby comprises a first aperture extending along a length thereof.

16. The frame mount according to claim 15, wherein the web comprises a second portion that is single-walled and comprises the second edge region.

17. The frame mount according to claim 14, wherein the flange is double-walled and thereby comprises an aperture extending along a length thereof.

18. A vehicle comprising:
a battery housing having a principal axis inclined relative to the horizontal when the vehicle is at rest on a horizontal driving surface.

19. The vehicle according to claim 18, wherein the principal axis of the battery housing is inclined relative to the horizontal by at least 1° and/or up to 5°.

20. The vehicle according to claim 18, wherein the battery housing is disposed in an underfloor area of the vehicle and between spaced apart axles of the vehicle.
